(19) United States
(12) Patent Application Publication
(10) Pub. No.: US 2015/0019083 A1
(43) Pub. Date: Jan. 15, 2015

(54) METHOD AND SYSTEM FOR HANDS-FREE OPERATION OF A POWER WINDOW OF A VEHICLE

(71) Applicant: MAGNA CLOSURES INC., Newmarket (CA)

(72) Inventors: Eric V. Kalliomaki, Uxbridge (CA); Spiridon-Sporin S. Tudora, Richmond Hill (CA); Stephen James Caron, Aurora (CA); Mirko Pribisic, North York (CA)

(73) Assignee: MAGNA CLOSURES INC.

(21) Appl. No.: 14/317,398

(22) Filed: Jun. 27, 2014

Related U.S. Application Data
(60) Provisional application No. 61/844,533, filed on Jul. 10, 2013.

(51) Int. Cl. E05F 15/20; G06F 3/01

(52) U.S. Cl. CPC E05F 15/2023; G06F 3/017; E05Y 2400/854; E05Y 2400/86
USPC 701/49

(57) ABSTRACT

A method for hands-free operation of a power window of a vehicle, comprising: determining an order of activation of a first sensor and a second sensor, the first sensor and the second sensor being spaced apart and located inside the vehicle proximate the power window; when the first sensor is activated before the second sensor, controlling a window pane of the power window to move toward a first position; when the second sensor is activated before the first sensor, controlling the window pane to move toward a second position; and, when the first sensor and the second sensor are activated simultaneously or approximately simultaneously while the window pane is moving, controlling the window pane to stop moving.

### CROSS REFERENCE TO RELATED APPLICATIONS

This application claims priority from and the benefit of the filing date of U.S. Provisional Patent Application No. 61/844,533, filed Jul. 10, 2013, and the entire content of such application is incorporated herein by reference

### FIELD OF THE DISCLOSURE

This disclosure relates to the field of hands-free operation of devices, and more specifically, to a method and system for hands-free operation of power windows of vehicles and other devices.

### BACKGROUND

This section provides background information related to the disclosure and is not a comprehensive disclosure of its full scope or all of its aspects, advantages and features.

In motor vehicles such as cars, sport utility vehicles and the like, it has become common practice to provide power operated windows, sun roofs, and the like. A power window is typically mounted in the vehicle body or chassis and has a window pane which is mounted on a track or rollers for sliding movement between an open position and a closed position. Typically, the power window may be operated manually or with a power drive mechanism or regulator including a reversible electric motor.

Systems exist for providing assistance in opening or for automatically opening the power windows of vehicles. These systems make use of manually-actuated switches mounted on door trim panels or center consoles within the vehicle and typically require at least one hand of an operator, driver, or user to be available. This can be problematic if the user is driving the vehicle. In particular, the user would need to take one hand off the steering wheel and avert his or her eyes from the road momentarily to activate the switches. In addition, systems exist which use sensors mounted within the internal trim of the vehicle which may be activated to open and close the power window by a user waving their hand proximate the sensors. However, these systems may be complex when attempting to avoid unintentional operation.

A need therefore exists for an improved method and system for hands-free operation of power windows of vehicles and other devices. Accordingly, a solution that addresses, at least in part, the above and other shortcomings is desired.

### SUMMARY

This section provides a general summary of the disclosure and is not a comprehensive disclosure of its full scope or all of its aspects, advantages and features.

According to one aspect of the disclosure, there is provided a method for hands-free operation of a power window of a vehicle, comprising: determining an order of activation of a first sensor and a second sensor, the first sensor and the second sensor being spaced apart and located inside the vehicle proximate the power window; when the first sensor is activated before the second sensor, controlling a window pane of the power window to move toward a first position; when the second sensor is activated before the first sensor, controlling the window pane to move toward a second position; and, when the first sensor and the second sensor are activated simultaneously or approximately simultaneously while the window pane is moving, controlling the window pane to stop moving.

In accordance with further aspects of the disclosure, there is provided an apparatus such as a gesture sensing module, control module, controller, etc., a method for adapting same, as well as articles of manufacture such as a computer readable medium or product and computer program product or software product (e.g., comprising a non-transitory medium) having program instructions recorded thereon for practising the method of the disclosure.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Features and advantages of the embodiments of the present disclosure will become apparent from the following detailed description, taken in combination with the appended drawings, in which:

FIG. 1 is front view illustrating a passenger compartment of a vehicle in accordance with an example embodiment of an aspect of the disclosure;

FIG. 2 is a block diagram illustrating a hands-free operation system for a power window of a vehicle in accordance with an example embodiment of an aspect of the disclosure;

FIG. 3 is a block diagram illustrating a capacitive gesture sensing module for the hands-free operation system of FIG. 2 in accordance with an example embodiment of an aspect of the disclosure;

FIG. 4 is a cross sectional view illustrating a capacitive sensor in accordance with an example embodiment of an aspect of the disclosure;

FIG. 5 is a graph illustrating capacitive signal level versus time for an “Up” hand gesture in accordance with an example embodiment of an aspect of the disclosure;

FIG. 6 is a graph illustrating capacitive signal level versus time for a “Down” hand gesture in accordance with an example embodiment of an aspect of the disclosure;

FIG. 7 is a graph illustrating capacitive signal level versus time for a “Stop” hand gesture in accordance with an example embodiment of an aspect of the disclosure;

FIG. 8 is a block diagram illustrating an alternate infrared gesture sensing module for the hands-free operation system of FIG. 2 in accordance with an example embodiment of an aspect of the disclosure; and,

FIG. 9 is a graph illustrating reflected infrared light intensity versus time for “Up” and “Down” hand gestures in accordance with an example embodiment of an aspect of the disclosure.

It will be noted that throughout the appended drawings, like features are identified by like reference numerals.

### DETAILED DESCRIPTION OF EXAMPLE EMBODIMENTS

In the following description, details are set forth to provide an understanding of the disclosure. In some instances, certain circuits, structures and techniques have not been described or shown in detail in order not to obscure the disclosure. The terms “gesture sensing module”, “control module”, and “controller” are used herein to refer to any machine for processing data, including the data processing systems, computer systems, electronic control units (“ECUs”), and network arrangements described herein. The present disclosure may be implemented in any computer programming language provided that the operating system of the controller provides the facilities that may support the requirements of the present disclosure. Any limitations presented would be a result of a particular type of operating system or computer programming language and would not be a limitation of the present disclosure. The present disclosure may also be implemented in hardware or in a combination of hardware and software.

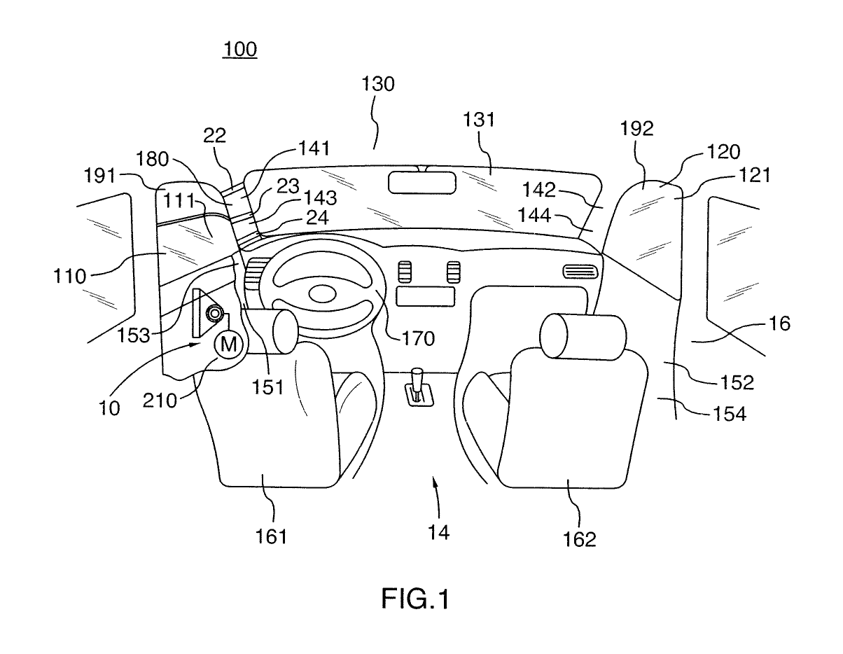

FIG. 1 is front view illustrating a passenger compartment 100 of a vehicle 14 in accordance with an example embodiment of an aspect of the disclosure. The vehicle body 16 forms a passenger compartment 100 of the vehicle 14 in which is implemented a hands-free operation system 10 for controlling the translation or operation of at least one power window, e.g., the driver-side power window 110, the passenger-side power window 120, etc. The vehicle body 16 includes a roof 130 and a pair of A-pillars 141, 142 spaced laterally and extending downwardly and forwardly at an angle from a forward end of the roof 130 on either side of the front windshield 131. Each pillar 141, 142 is covered by a pillar trim panel 143, 144 fixedly mounted to the A-pillar 141, 142. The vehicle body 16 also includes a driver front door 151 and a passenger front door 152. Each door 151, 152 has a power window frame or power window 110, 120 having a respective window pane 111, 121 and a respective window lift motor 210 (only the driver window lift motor 210 is shown in FIG. 1) for translating the window pane 111, 121 and a respective door trim panel 153, 154. The passenger compartment 100 also includes a driver seat 161 and a passenger seat 162 which are slidingly engaged to the vehicle's floor. The driver seat 161 is disposed behind the steering wheel 170.

The pillar trim panel 143 is located proximate to the driver seat 161 and includes two or more proximity sensors 22, 23, 24. The first sensor 22 is positioned on an upper part of the pillar trim panel 143, the second sensor 23 is positioned on a middle part of the pillar trim panel 143, and the third sensor 24 is positioned on a lower part of the pillar trim panel 143. The exterior surface of the pillar trim panel 143 may be covered by a cloth or other material (not shown) such that the sensors 22, 23, 24 are not visible or barely visible to the user and hence unwanted user distraction is avoided. Similarly, the pillar trim panel 144 located proximate to the passenger seat 162 may also be equipped with sensors.

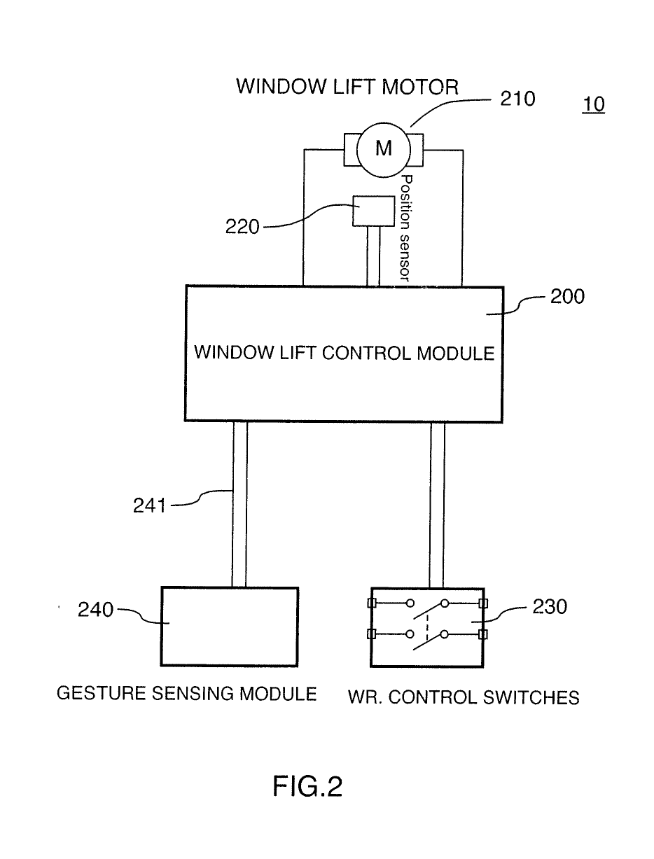

FIG. 2 is a block diagram illustrating a hands-free operation system 10 for a power window 110 of a vehicle 14 in accordance with an example embodiment of an aspect of the disclosure. The hands-free operation system 10 is shown operatively associated with a closure panel 110 of the motor vehicle 14. According to one example embodiment, the closure panel is a power window 110. It will be understood by those skilled in the art that the hands-free operation system 10 may be used with other closure panels, sun roofs, and windows of a vehicle or other device.

The power window 110 is mounted in the body 16 of the vehicle 14 and has a window pane 111 which is mounted on a track or rollers for sliding movement between an open position 191 (see pane 111) and a closed position 192 (see pane 121). Typically, the power window 110 may be operated manually or with a power drive mechanism or regulator including a reversible electric motor 210. The pane 111 of the power window 110 typically moves “Up” to reach the closed position 192 and moves “Down” to reach the open position 191. The power window 110 is opened and closed by a drive mechanism including an electric window lift motor 210 which is controlled by a window lift control module 200. A position sensor 220 is monitored by the window lift control module 200 to determine the position of the window pane 111 (e.g., in the fully open position or the fully closed position 192 or a position therebetween 191). The window lift control module 200 may also monitor the position or activation of control switches 230 coupled thereto for manually controlling the power window 110. For hands-fee operation of the power window 110, the window lift control module 200 monitors signals received from a gesture sensing module 240 coupled thereto.

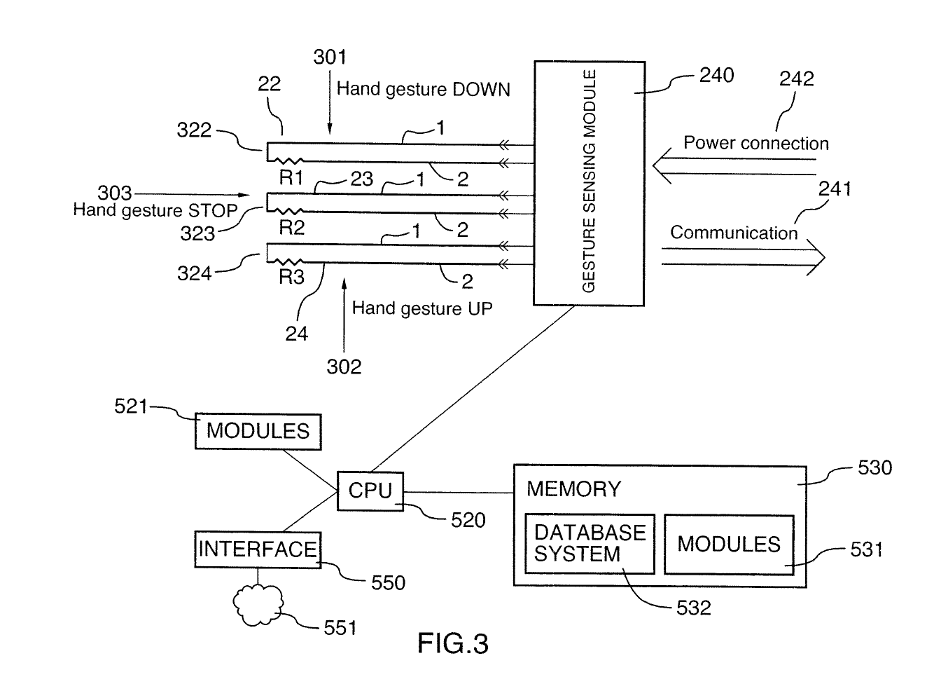

FIG. 3 is a block diagram illustrating a capacitive gesture sensing module 240 for the hands-free operation system 10 of FIG. 2 in accordance with an example embodiment of an aspect of the disclosure. The capacitive gesture sensing module 240 includes a power connection or interface 242 to the battery of the vehicle 14 and a communication connection or interface 241 to at least the window lift control module 200. The gesture sensing module 240 may be a separate electronic control unit (“ECU”) or may be coupled to or incorporated in the vehicle's window lift control module 200. Each of the window lift control module 200 and gesture sensing module 240 may include a controller or processor, memory, etc.

In particular, the gesture sensing module (or controller) 240 may include a processor or central processing unit (“CPU”) 520, memory 530, and an interface device 550. The memory 530 may include a variety of storage devices including internal memory and external mass storage typically arranged in a hierarchy of storage as understood by those skilled in the art. For example, the memory 530 may include databases, random access memory (“RAM”), read-only memory (“ROM”), flash memory, and/or disk devices. The interface device 550 may include one or more network connections. The gesture sensing module 240 may be adapted for communicating with other data processing systems (e.g., similar to the gesture sensing module 240 such as the window lift control module (or controller) 200) over a network 551 (or 241) via the interface device 550. For example, the interface device 550 may include an interface to a network 551 such as a local area network (“LAN”), etc. As such, the interface 550 may include suitable transmitters, receivers, etc. Thus, the gesture sensing module 240 may be linked to other data processing systems by the network 551. The CPU 520 may include or be operatively coupled to dedicated coprocessors, memory devices, or other hardware modules 521. The CPU 520 is operatively coupled to the memory 530 which stores an operating system (e.g., 531) for general management of the gesture sensing module 240. The gesture sensing module 240 may include a data store or database system 532 for storing data and programming information. The database system 532 may include a database management system (e.g., 532) and a database (e.g., 532) and may be stored in the memory 530 of the gesture sensing module 240. In general, the gesture sensing module 240 has stored therein data representing sequences of instructions which when executed cause the method described herein to be performed. Of course, the gesture sensing module 240 may contain additional software and hardware a description of which is not necessary for understanding the disclosure.

Thus, the gesture sensing module 240 includes computer executable programmed instructions for directing the gesture sensing module 240 to implement the embodiments of the present disclosure. The programmed instructions may be embodied in one or more hardware modules 521 or software modules 531 resident in the memory 530 of the gesture sensing module 240 or elsewhere (e.g., 520, 200). Alternatively, the programmed instructions may be embodied on a computer readable medium or product (e.g., a memory stick, etc.) which may be used for transporting the programmed instructions to the memory 530 of the gesture sensing module 240. Alternatively, the programmed instructions may be embedded in a computer-readable signal or signal-bearing medium or product that is uploaded to a network 551 by a vendor or supplier of the programmed instructions, and this signal or signal-bearing medium may be downloaded through an interface (e.g., 550) to the gesture sensing module 240 from the network 551 by end users or potential buyers.

The window lift control module (or controller) 200 may have a configuration similar to that of the gesture sensing module (or controller) 240.

According to one example embodiment, the hands-free operation system 10 includes two or more proximity sensors 22, 23, 24 which are coupled to the gesture sensing module 240. The sensors 22, 23, 24 are spaced apart and disposed in such a way that the first sensor 22 is on the upper part of the pillar trim panel 143, the second sensor 23 is on the middle part of the pillar trim panel 143, and the third sensor 24 is on the lower part of the pillar trim panel 143. The sensors 22, 23, 24 may be electrically coupled to an optional wire harness (not shown) adapted to plug into the gesture sensing module 240. The gesture sensing module 240 provides appropriate electrical signals via the communication interface 241 (or 550) to the window lift control module 200 which drives the motor 210 to open and close the power window 110 in response. The gesture sensing module 240 monitors the capacitance of each of the sensors 22, 23, 24 to determine if and what signals should be generated and communicated to the window lift control module 200. Each sensor 22, 23, 24 may have an associated proximity range within which it may sense an object (e.g., a user's hand).

The sensors 22, 23, 24 may come in different forms, including non-contact proximity sensors which are typically based on capacitance changes. These are referred to as capacitive sensors in the following.

Capacitive sensors typically include a conductive strip, including, for example, a metal strip or wire. The conductive strip may be embedded in a non-conductive material, such as a non-conductive plastic or rubber strip, which is mounted in the pillar trim 143. The metal strip or wire and the body 16 of the vehicle 14 may collectively form the two plates of a sensing capacitor. Alternatively, the sensor 22, 23, 24 may incorporate two discrete electrodes separately, or embedded together within the non-conductive material. An example of such a sensor 22, 23, 24 is described below. An obstacle placed near these two electrodes changes the dielectric constant and thus varies the amount of charge stored by the sensing capacitor over a given period of time. The charge stored by the sensing capacitor is transferred to a reference capacitor in order to detect the presence of the obstacle. The capacitive sensor is typically driven by a pulsed signal from a controller such as the gesture sensing module 240. Example sensors and possible mountings to a fascia are described in U.S. Patent Application No. 61/791,472 by Pribisic, et al., filed Mar. 15, 2013, the entire content of which is hereby incorporated by reference, and in U.S. Patent Application No. 61/791,322 by Pribisic et al., filed Mar. 15, 2013, the entire content of which is hereby incorporated by reference. Example driving of a sensor, particularly to minimize electrical noise, is described in U.S. Patent Application No. 61/791,779 by Pribisic et al., filed Mar. 15, 2013, the entire content of which is hereby incorporated by reference. It is to be recognized that these are only example capacitive sensors 22, 23, 24 and other capacitive proximity sensors, or non-capacitive proximity sensors, such as, for example, optical sensors, acoustic sensors, or radio frequency (fob based) sensors may be used. The use of infra-red sensors is described in more detail below.

As shown in FIG. 3, a capacitive sensor circuit 322 for the first capacitive sensor 22 may be formed by a capacitive sensor electrode 1, a terminal resistor R1, and a capacitive shield electrode 2. A capacitive sensor circuit 323 for the second capacitive sensor 23 may be formed by a capacitive sensor electrode 1, a terminal resistor R2, and a capacitive shield electrode 2. And, a capacitive sensor circuit 324 for the third capacitive sensor 24 may be formed by a capacitive sensor electrode 1, a terminal resistor R3, and a capacitive shield electrode 2. The resistors R1, R2, R3 may be diagnostic resistors for the sensor circuits 322, 323, 324. The capacitive sensor circuits 322, 323, 324 are coupled to and driven by the gesture sensing module 240.

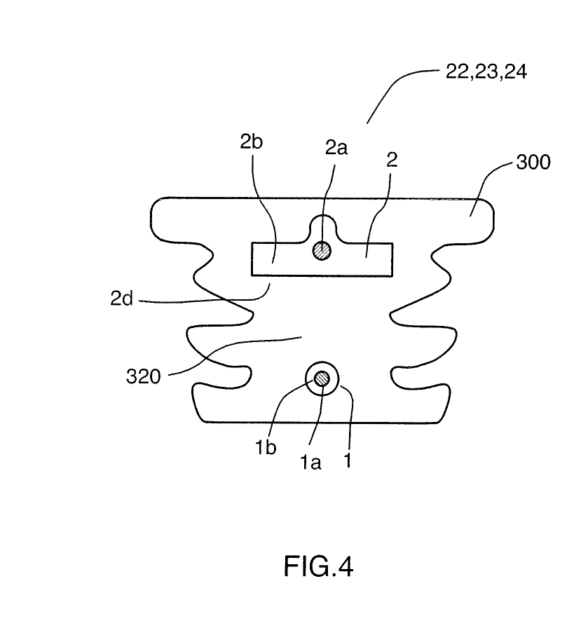

FIG. 4 is a cross sectional view illustrating a capacitive sensor 22, 23, 24 in accordance with an example embodiment of an aspect of the disclosure. The capacitive sensor 22, 23, 24 is a two electrode sensor that allows for a capacitive mode of obstacle detection. In general, the two electrodes 1, 2 function in a driven shield configuration (i.e., with the upper electrode 2 being the driven shield). The case 300 positions the two electrodes 1, 2 in an arrangement that facilitates operation of the sensor 22 in a capacitive mode. The lower electrode 1 (optionally comprising a conductor 1a embedded in conductive resin 1b) acts as a capacitive sensor electrode, and the upper electrode 2 (optionally comprising a conductor 2a embedded in a conductive resin 2b) acts as a capacitive shield electrode. A dielectric 320 (e.g., a portion 320 of the case 300) is disposed between the capacitive shield electrode 2 and the capacitive sensor electrode 1 to isolate and maintain the distance between the two. The gesture sensing module 240 is in electrical communication with the electrodes 1, 2 for processing sense data received therefrom. Accordingly to one embodiment, the capacitive sensor 22, 23, 24 may be similar to that described in U.S. Pat. No. 6,946,853 to Gifford et al., issued Sep. 20, 2005, and incorporated herein by reference.

According to one example embodiment, the capacitive sensor 22, 23, 24 includes an elongate non-conductive case 300 having two elongate conductive electrodes 1, 2 extending along its length. The electrodes 1, 2 are encapsulated in the case 300 and are spaced apart. When an object such as a user's hand enters a volume 180 proximate the pillar trim panel 143 (e.g., between the pillar trim panel 143 and the steering wheel 170), it effects the electric field generated by the capacitive sensor electrode 1 which results in a change in capacitance between the two electrodes 1, 2 which is indicative of the proximity of the object to the pillar trim panel 143. Hence, the two electrodes 1, 2 function as a capacitive non-contact or proximity sensor.

According to one example embodiment, the capacitive sensor electrode 1 may include a first conductor 1a embedded in a first partially conductive body 1b and the capacitive shield electrode 2 may include a second conductor 2a embedded in a second partially conductive body 2b. The conductors 1a, 2a may be formed from a metal wire. The partially conductive bodies 1b, 2b may be formed from a conductive resin. And, the case 300 may be formed from a non-conductive (e.g., dielectric) material (e.g., rubber, etc.). Again, the capacitive sensor electrode 1 is separated from the capacitive shield electrode 2 by a portion 320 of the case 300.

With respect to capacitive sensing, a portion 320 of the case 300 electrically insulates the capacitive sensor electrode 1 and the capacitive shield electrode 2 so that electrical charge can be stored therebetween in the manner of a conventional capacitor. According to one embodiment, the inner surface 2d of the capacitive shield electrode 2 may be shaped to improve the shielding function of the electrode 2. According to one embodiment, the inner surface 2d may be flat as shown in FIG. 4.

The sensor 22, 23, 24 is used by the gesture sensing module 240 to measure a capacitance (or capacitance value) which is dependent on an electric field extending through the volume 180 proximate the pillar trim panel 143. According to one embodiment, the capacitive shield electrode 2 functions as a shielding electrode since it is positioned closer to the sheet metal of the body 16. As such, the electric field sensed by the capacitive sensor electrode 1 will be more readily influenced by the closer capacitive shield electrode 2 than the vehicle sheet metal.

According to another example embodiment, the sensors 22, 23, 24 may be optical sensors, infrared sensors, ultrasonic sensors, motion detectors, image recognition sensors, inductive sensors, accelerometers, G-sensors, or any other form of sensor that can detect the presence or motion of a user's hand within the volume 180 proximate the pillar trim panel 143.

In operation, when a user moves his or her hand in the volume 180 proximate to the sensors 22, 23, 24, the sensors 22, 23, 24 are sequentially activated. The activation of the sensors 22, 23, 24 is detected by the gesture sensing module 240 which sends an appropriate signal over the communication interface 241 (or 550) to the window lift control module 200. In response, the window lift control module 200 operates the window lift motor 210 to move the window pane 111 to its open, partially open, or closed positions 191, 192 in accordance with the user's hand movement. In particular, the user may make an upward hand wave motion or gesture 302 to generate a command to move the window pane 111 up, the user may make a downward hand wave motion or gesture 301 to generate a command to move the window pane 111 down, and the user may make an inward hand motion or gesture 303 (i.e., toward closer proximity to the sensors 22, 23, 24) while window pane 111 is in motion to generate a command to stop movement of the window pane 111.

It will be appreciated by those skilled in the art that the hands-free operation system 10 may be applied to any motorized or automated closure panel structure that moves between an open position 191 and a closed position 192. For example, a non-exhaustive list of closure panels includes window panes, sliding doors, tailgates, liftgates, sunroofs and the like. For applications such as window panes or sun roofs, the sensors 22, 23, 24 may be mounted within the passenger compartment 100 of the vehicle 14, and for applications such as powered liftgates and sliding doors, the sensors 22, 23, 24 may be mounted on the external body 16 of the vehicle 14.

According to one example embodiment, user hand gesture sensing is performed using two or more sensors 22, 23, 24 and the gesture sensing module 240 with its communication and power interfaces 241, 242. As mentioned above, each capacitive sensor circuit 322, 323, 324 includes a termination resistor R1, R2, R3, sensor electrode 1, and background driven shield electrode 2. The termination resistors R1, R2, R3 are used diagnostically in order to check for electrode disconnection. The sensor electrodes 1 are used to measure capacitive charge. The background driven shield electrodes 2 serve to minimize parasitic background capacitance between the sensing electrodes 1 and sheet metal of the vehicle's body 16.

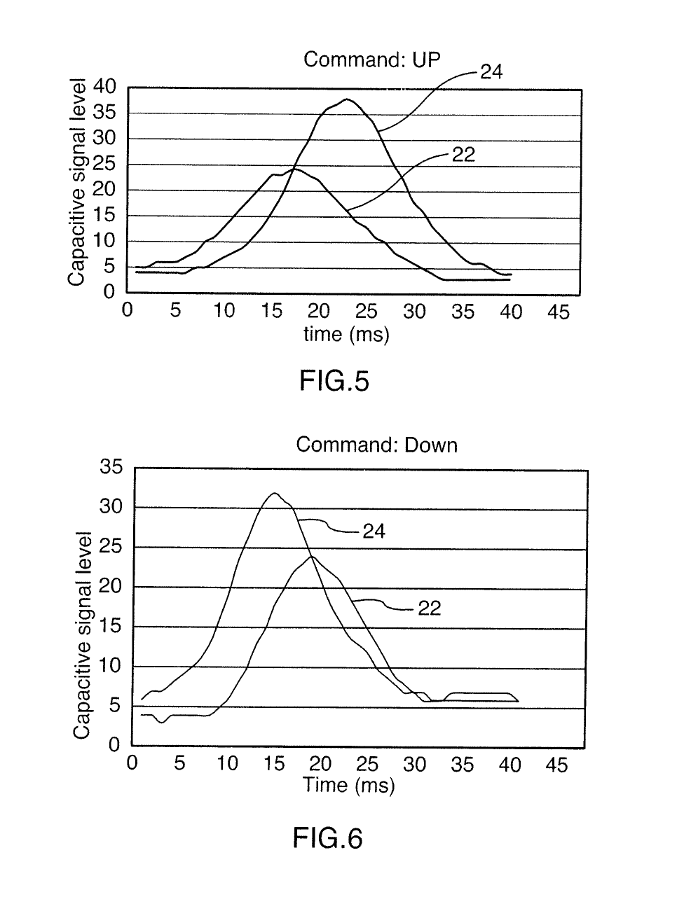

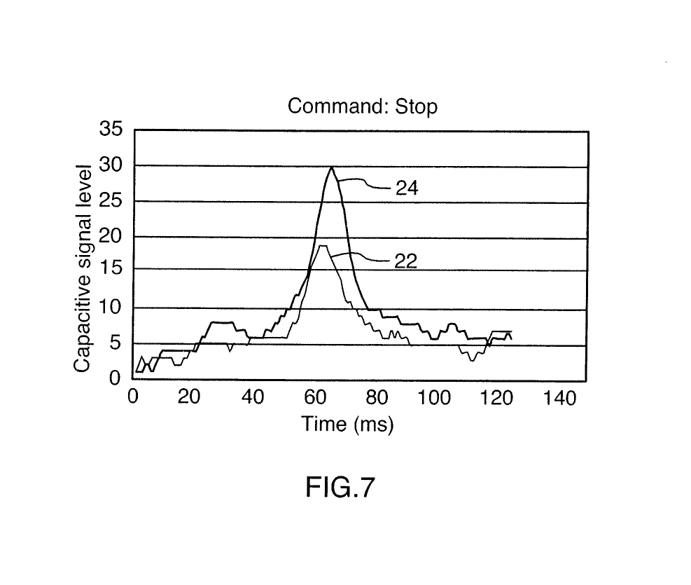

FIG. 5 is a graph illustrating capacitive signal level versus time for an “Up” hand gesture in accordance with an example embodiment of an aspect of the disclosure. FIG. 6 is a graph illustrating capacitive signal level versus time for a “Down” hand gesture in accordance with an example embodiment of an aspect of the disclosure. And, FIG. 7 is a graph illustrating capacitive signal level versus time for a “Stop” hand gesture in accordance with an example embodiment of an aspect of the disclosure. The motion of a user's hand is detected by observing two or more signals from the sensors 22, 23, 24 which are spaced (e.g., vertically or approximately vertically, etc.) appropriate distances apart along the pillar trim panel 143 to maximize signal differentiation between them.

Referring to FIG. 5, detecting a capacitive signal peak from the third sensor 24 followed by a capacitive signal peak from the first sensor 22 may be interpreted as a window “Up” hand gesture 302. Referring to FIG. 6, detecting a capacitive signal peak from the first sensor 22 followed by a capacitive signal peak from the third sensor 24 may be interpreted as a window “Down” hand gesture 301. Referring to FIG. 7, if no time delay between capacitive signal peaks is detected, or if capacitive signal peaks overlap, or if a capacitive signal magnitude change is detected during window pane motion, such may be interpreted as a window “Stop” hand gesture 303.

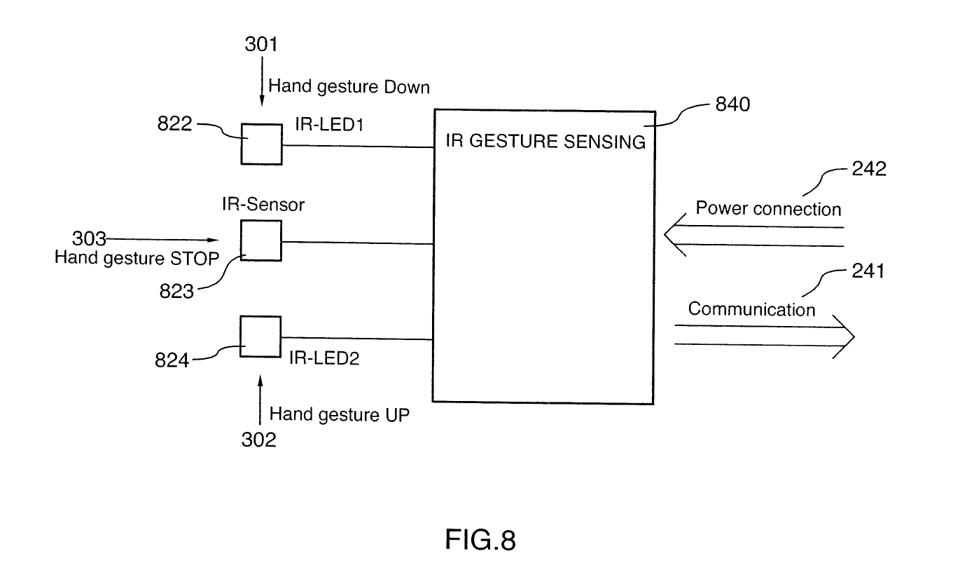

FIG. 8 is a block diagram illustrating an alternate infrared gesture sensing module 840 for the hands-free operation system 10 of FIG. 2 in accordance with an example embodiment of an aspect of the disclosure. In FIG. 8, rather than having using two or more capacitive sensors 22, 23, 24, the gesture sensing module 840 uses two or more infrared sensors 822, 823, 824. In particular, for infrared gesture sensing, two or more infrared (“IR”) emitters (e.g., IR light emitting diodes (“LEDs”)) 822, 824, an infrared sensor 823, and an infrared gesture sensing module 840 with communication and power interfaces 241, 242 may be used. The infrared gesture sensing module (or controller) 840 may have a configuration similar to that of the capacitive gesture sensing module (or controller) 240.

Reflected infrared light from individual emitters 822, 824 is captured by the infrared sensor 823 and measured periodically under software control by a controller or processor 520 within the infrared gesture sensing module 840. The infrared sensor 823 captures higher intensity reflected light from an IR emitter 822, 824 when an object is proximate than when the object is further away. As a result, time shifted signals from multiple emitters may be observed when a user moves his or her hand sequentially over the emitters. For reliable gesture detection, the infrared emitters and sensors 822, 823, 824 should be spaced apart appropriately.

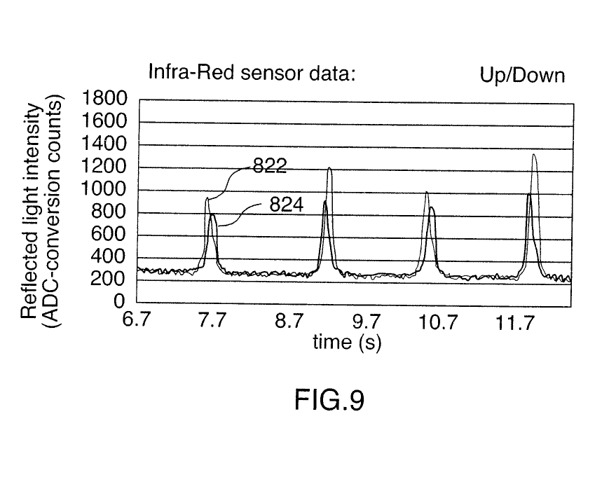

FIG. 9 is a graph illustrating reflected infrared light intensity versus time for “Up” and “Down” hand gestures 302, 301 in accordance with an example embodiment of an aspect of the disclosure. User hand gestures are detected by observing two or more reflected light signals at the infrared sensor 823 from the infrared emitters 822, 824, which are spaced by an appropriate distance to maximize signal differentiation. Detecting a reflected light signal peak from the second infrared emitter 824 followed by a reflected light signal peak from the first infrared emitter 822 may be interpreted as a window “Up” hand gesture 302. Detecting a reflected light signal peak from the first infrared emitter 822 followed by a reflected light signal peak from the second infrared emitter 824 may be interpreted as a window “Down” hand gesture 301. If no time delay between reflected light signal peaks is detected, or if reflected light signal peaks overlap, or if a reflected light signal magnitude change is detected during window pane motion, such may be interpreted as a window “Stop” hand gesture 303. According to one example embodiment, if the infrared sensor 823 detects a hand gesture 301, 302, 303 while the window pane 111 is moving, the infrared gesture sensing module 840 will control the window pane 111 to stop moving.

According to one example embodiment, in order to avoid false activation of the sensors 22, 23, 24, which may be caused by a user adjusting air vents or turning the steering wheel 170, etc., the sensitivities of the sensors 22, 23, 24 and/or the gesture sensing module 240 may be adjusted. According to another example embodiment, the location of the sensors 22, 23, 24 may be selected to avoid or reduce false activation. For example, rather than being located on the pillar trim panel 143, the sensors 22, 23, 24 may be located on the door trim panel 153. In particular, the sensors 22, 23, 24 may be located in the mirror flag portion of the door trim panel 153 where there is access to the wiring route used by the power window 110 and the power mirror.

The above embodiments may contribute to an improved method and system 10 for hands-free operation of power windows 11 of vehicles 14 and other devices and may provide one or more advantages. First, the embodiments may provide improved user safety. In particular, instead of a user taking his or her eyes off the road to search for a power window switch, the user need only wave their hand near the pillar trim panel 143 (e.g., near the mirror flag). The user may make an upward hand wave motion to move the window pane 111 up, may make a downward hand wave motion to move the window pane 111 down, and may make an inward hand motion (i.e., toward closer proximity to the sensors 22, 23, 24) while the window pane 111 is in motion to stop movement of window pane 111. Second, locating the sensors 22, 23, 24 in or under the pillar trim panel 143 (or under the mirror flag of the door trim panel 153) keeps them away from existing window or mirror switches. Third, the embodiments incorporate a gesture sensing mechanism which allows for the movement of the driver's side window 110 up or down without the use of window switches located on the door trim panel 153, thereby allowing the user to keep their eyes on the road (e.g., there is no need for a user to look down at their door or take their eyes off the road in order to operate the user's window). Fourth, the embodiments provide an intuitive gesture window control interface which improves user comfort, convenience, and safety during vehicle operation. The gesture window control interface provides: reliable and intuitive interpretation of user commands; appropriate sensing distance; improved sensor positioning with respect to the user; and, reduced false gesture signal interpretation.

Thus, according to one example embodiment, there is provided a method for hands-free operation of a power window 110 of a vehicle 14, comprising: determining an order of activation of a first sensor 22 and a second sensor 24, the first sensor 22 and the second sensor 24 being spaced apart and located inside the vehicle 14 proximate the power window 110; when the first sensor 22 is activated before the second sensor 24, controlling a window pane 111 of the power window 110 to move toward a first position (e.g., the closed position 192); when the second sensor 24 is activated before the first sensor 22, controlling the window pane 111 to move toward a second position (e.g., the open position 191); and, when the first sensor 22 and the second sensor 24 are activated simultaneously or approximately simultaneously while the window pane 111 is moving, controlling the window pane 111 to stop moving.

In the above method, the first sensor 22 and the second sensor 24 may be capacitive proximity sensors. The determining of the order of activation of the first sensor 22 and the second sensor 24 may further include comparing respective occurrences of capacitive signal level peak magnitude for the first sensor 22 and the second sensor 24 (see FIGS. 5-7). The first sensor 22 and the second sensor 24 may be located on a pillar trim panel 143. The first sensor 22 and the second sensor 24 may be located on a door trim panel 153. The first sensor 22 and the second sensor 24 may be located in a mirror flag portion of the door trim panel 153. The determining the order of activation of the first sensor 22 and the second sensor 24 may be performed using a processor 520. The processor 520 may be included in a control or sensing module 200, 240. The first sensor 22 and the second sensor 24 may be spaced apart vertically or approximately vertically. And, the first sensor 22 and the second sensor 24 may be spaced apart horizontally or approximately horizontally.

While aspects of this disclosure may be primarily discussed as a method, a person of ordinary skill in the art will understand that the apparatus discussed above with reference to a gesture sensing module 240 (or 200 or 840) may be programmed to enable the practice of the method of the disclosure. Moreover, an article of manufacture for use with a gesture sensing module 240, such as a pre-recorded storage device or other similar computer readable medium or computer program product including program instructions recorded thereon, may direct the gesture sensing module 240 to facilitate the practice of the method of the disclosure. It is understood that such apparatus, products, and articles of manufacture also come within the scope of the disclosure.

In particular, the sequences of instructions which when executed cause the method described herein to be performed by the gestures sensing module 240 may be contained in a data carrier product according to one embodiment of the invention. This data carrier product may be loaded into and run by the gesture sensing module 240. In addition, the sequences of instructions which when executed cause the method described herein to be performed by the gesture sensing module 240 may be contained in a computer software product or computer program product (e.g., comprising a non-transitory medium) according to one embodiment of the invention. This computer software product or computer program product may be loaded into and run by the gesture sensing module 240. Moreover, the sequences of instructions which when executed cause the method described herein to be performed by the gesture sensing module 240 may be contained in an integrated circuit product (e.g., a hardware module or modules 521) which may include a coprocessor or memory according to one embodiment of the invention. This integrated circuit product may be installed in the gesture sensing module 240.

The embodiments of the invention described above are intended to be examples only. Those skilled in this art will understand that various modifications of detail may be made to these embodiments, all of which come within the scope of the invention.

What is claimed is:

1. A method for hands-free operation of a power window of a vehicle, comprising:
determining an order of activation of a first sensor and a second sensor, the first sensor and the second sensor being spaced apart and located inside the vehicle proximate the power window;
when the first sensor is activated before the second sensor, controlling a window pane of the power window to move toward a first position;
when the second sensor is activated before the first sensor, controlling the window pane to move toward a second position; and,
when the first sensor and the second sensor are activated simultaneously or approximately simultaneously while the window pane is moving, controlling the window pane to stop moving.

2. The method of claim 1 wherein the first sensor and the second sensor are capacitive proximity sensors.

3. The method of claim 2 wherein the determining of the order of activation of the first sensor and the second sensor further comprises comparing respective occurrences of capacitive signal level peak magnitude for the first sensor and the second sensor.

4. The method of claim 1 wherein the first sensor and the second sensor are located on a pillar trim panel.

5. The method of claim 1 wherein the first sensor and the second sensor are located on a door trim panel.

6. The method of claim 5 wherein the first sensor and the second sensor are located in a mirror flag portion of the door trim panel.

7. The method of claim 1 wherein the determining the order of activation of the first sensor and the second sensor is performed using a processor.

8. The method of claim 7 wherein the processor is included in a control or sensing module.

9. The method of claim 1 wherein the first sensor and the second sensor are spaced apart vertically or approximately vertically.

10. The method of claim 1 wherein the first sensor and the second sensor are spaced apart horizontally or approximately horizontally.

11. A system for hands-free operation of a power window of a vehicle, comprising:
a processor coupled to memory, a first sensor, and a second sensor; and,
at least one of hardware and software modules within the memory and controlled or executed by the processor, the modules including:
a module for determining an order of activation of the first sensor and the second sensor, the first sensor and the second sensor being spaced apart and located inside the vehicle proximate the power window;
a module for, when the first sensor is activated before the second sensor, controlling a window pane of the power window to move toward a first position;
a module for, when the second sensor is activated before the first sensor, controlling the window pane to move toward a second position; and,
a module for, when the first sensor and the second sensor are activated simultaneously or approximately simultaneously while the window pane is moving, controlling the window pane to stop moving.

12. The system of claim 11 wherein the first sensor and the second sensor are capacitive proximity sensors.

13. The system of claim 12 wherein the module for determining of the order of activation of the first sensor and the second sensor further comprises a module for comparing respective occurrences of capacitive signal level peak magnitude for the first sensor and the second sensor.

14. The system of claim 11 wherein the first sensor and the second sensor are located on a pillar trim panel.

15. The system of claim 11 wherein the first sensor and the second sensor are located on a door trim panel.

16. The system of claim 15 wherein the first sensor and the second sensor are located in a mirror flag portion of the door trim panel.

17. The system of claim 11 wherein the processor is included in a control or sensing module within the system.

18. The system of claim 11 wherein the first sensor and the second sensor are spaced apart vertically or approximately vertically.

19. The system of claim 11 wherein the first sensor and the second sensor are spaced apart horizontally or approximately horizontally.

20. A method for hands-free operation of a power window of a vehicle, comprising:
determining an order of occurrence of a first signal level peak magnitude for a first sensor and a second signal level peak magnitude for a second sensor, the first sensor and the second sensor being spaced apart and located inside the vehicle proximate the power window;
when the first signal level peak magnitude occurs before the second signal level peak magnitude, controlling a window pane of the power window to move toward a first position;
when the second signal level peak magnitude occurs before the first signal level peak magnitude, controlling the window pane to move toward a second position; and,
when the first signal level peak magnitude and the second signal level peak magnitude occur simultaneously or approximately simultaneously while the window pane is moving, controlling the window pane to stop moving.
